(19) United States
(12) Patent Application Publication
(10) Pub. No.: US 2014/0171181 A1
(43) Pub. Date: Jun. 19, 2014

(54) GAMING INTELLIGENCE SYSTEM AND METHOD

(71) Applicant: New BIS Safe Luxco S.à r.I., Luxembourg (LU)

(72) Inventor: Andrew John CARDNO, San Diego, CA (US)

(21) Appl. No.: 14/038,068

(22) Filed: Sep. 26, 2013

Related U.S. Application Data
(60) Provisional application No. 61/707,433, filed on Sep. 28, 2012.

(51) Int. Cl. G07F 17/32

(52) U.S. Cl. CPC G07F 17/323
USPC 463/25

(57) ABSTRACT

A Gaming Intelligence System and Method are described, the method comprising correlating player and game information from two sets of gaming information obtained from a plurality of gaming machines. The first set of information includes player information and transactional information and the second set of information includes game information and transactional information. By optimizing an allocation of transactional information using a goodness measure, correlations between player information and game information are obtained. A gaming intelligence system that determines correlations between player IDs and game IDs is also described.

This application claims benefit of U.S. Provisional Ser. No. 61/707,433, filed 28 Sep. 2012 and which application is incorporated herein by reference. To the extent appropriate, a claim of priority is made to the above disclosed application.

### FIELD OF THE INVENTION

This invention relates to a gaming intelligence system and method for correlating game and player information from independent information sources.

### BACKGROUND OF THE INVENTION

Many conventional gaming machines have two separate systems for collecting operational data. The first collects transaction information and player information. The second collects transaction information and game information. The transactional information typically includes game plays, amounts paid in (Coin In), amounts paid out (Coin Out) and Jackpots.

To date it has not been possible to relate game information to players. This would be useful for marketing purposes and to optimize gaming operations including machine layout and gaming machine operation.

It is an object of the invention to provide a gaming intelligence system and method that provides such functionality or to at least provide the public with a useful choice.

### SUMMARY OF THE INVENTION

According to one exemplary embodiment there is provided a method of correlating player and game information from two sets of gaming information obtained from a plurality of gaming machines wherein a first set of information includes player information and transactional information and a second set of information includes game information and transactional information wherein by optimizing an allocation of transactional information using a goodness measure correlations between player information and game information are obtained.

According to another exemplary embodiment there is provided a gaming intelligence system comprising:
a. a plurality of gaming machines, each machine including:
   i. a first monitoring unit that stores information relating to a player ID and transaction information; and
   ii. a second monitoring unit that stores information relating to a game ID and transaction information,
b. an evaluation system that receives information relating to player ID, game ID and transaction information from the monitoring units and determines correlations between player IDs and game IDs by correlating transaction information.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any prior art in this specification does not constitute an admission that such prior art forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of exemplary embodiments given below, serve to explain the principles of the invention.

FIG. 1 shows a gaming intelligence system according to one aspect of the present invention.

### DETAILED DESCRIPTION OF EMBODIMENTS OF THE INVENTION

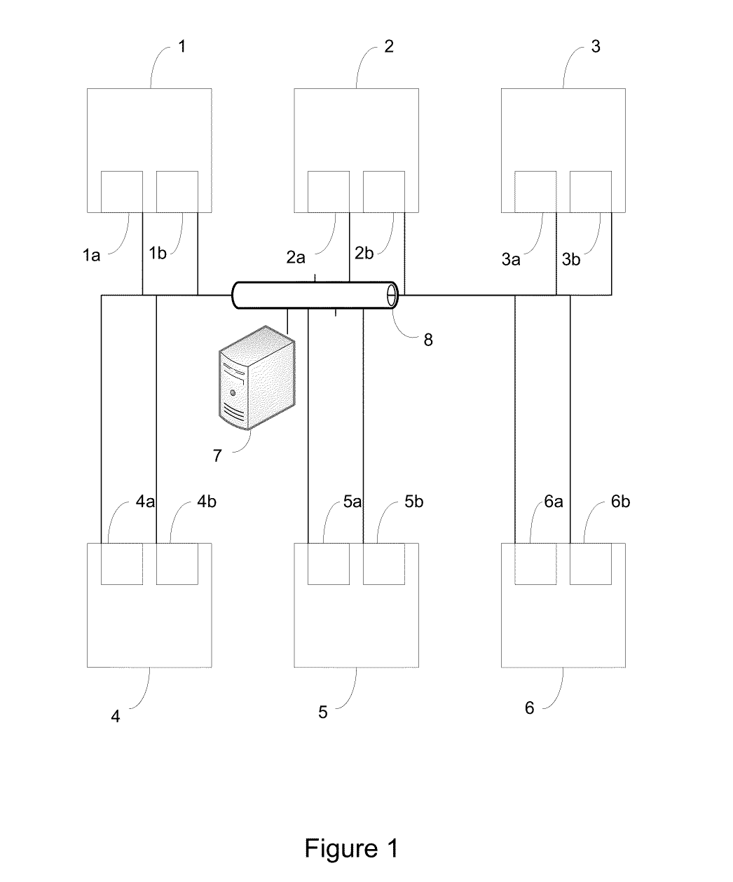

Referring to FIG. 1 there is shown a gaming intelligence system according to one embodiment. A plurality of gaming machines 1 to 6 each have a first monitoring unit 1a to 6a that monitors player IDs and transactional information relating to each player including Game plays, Coin In, Coin Out and Jackpots. Gaming machines 1 to 6 each also have a second monitoring unit 1b to 6b that monitors game IDs and transactional information relating to each game including Game plays, Coin In, Coin Out and Jackpots.

Data from the monitoring units 1a to 6a and 1b to 6b is supplied over a communications network 8 (that may be wired or wireless) to a data analysis system 7. Data analysis system 7 may determine precise or optimized correlations between players and games played. The term “correlation” in this specification refers to associations between players and games and not necessarily a statistical relationship.

### EXAMPLE

The method of the invention will be illustrated by way of example. In the example the actual data is as shown in Table 1 below but this information is not available in the gaming systems to which this invention is directed.

TABLE 1
Actual data (not available)

| Machine | | | | |
|---|---|---|---|---|
| Theme | Player | Games | CoinIn | CoinOut |
| Keno | Charles | 5 | 10 | 8 |
| Keno | Bob | 10 | 20 | 30 |
| Video Poker | Alice | 8 | 40 | 38 |
| Video Poker | Bob | 1 | 1 | 0 |
| Video Poker | Not | 6 | 12 | 14 |
| | Recorded | | | |
| Slots | Not | 9 | 15 | 13 |
| | Recorded | | | |

The actual data available is that from monitoring units 1a to 6a relating to player and transactional data as shown in table 2 below and that from monitoring units 1b to 6b relating to game and transactional data as shown in table 3 below.

TABLE 2
Player Data

| Player | Game plays | CoinIn | CoinOut |
|---|---|---|---|
| Alice | 8 | 40 | 38 |
| Bob | 11 | 21 | 30 |
| Charles | 5 | 10 | 8 |

TABLE 3
Machine Data

| Machine | | | |
|---|---|---|---|
| Theme | Game plays | CoinIn | CoinOut |
| Keno | 15 | 30 | 38 |
| Video Poker | 15 | 53 | 52 |
| Slots | 9 | 15 | 13 |

Tables may then be compiled providing an initial allocation of games to players for each field of transaction information. Tables 4 to 6 show such tables for Games, Coin In and Coin Out. The tables 4 to 6 include totals from tables 2 and 3 and error values for each row and column representing the difference between the totals row or column and the sum of the table values in the row or column.

The initial table values may be allocated in a number of ways including:
1. Easy allocation—according to this method as much value as possible is allocated to table cells as they are sequentially populated from one side to the other or up or down. As the name suggests this approach is simple to implement.
2. Greedy algorithm—as much value as possible is allocated to the largest values first—this approach may result in fast convergence but it may not necessarily be the best approach for optimization.
3. Random—according to this method rows or columns are selected randomly as much value as possible as possible is allocated to each selected row or column.

Error values are calculated after the tables are populated.

Table 4 has been populated using the Easy allocation method. The totals 8, 11 and 5 are obtained from the first column of table 2. The totals 15, 15 and 9 are obtained from first column of able 3. The first table cell to filled using the Easy allocation method is the Alice:Keno cell. From table 2 it is known that Alice has had 8 game plays and so these are all allocated to this cell. The next cell is the Bob:Keno cell and although Bob has had 11 game plays only 7 are available in view of the total of 15 for the row. As the total row value has been reached all remaining row values must be zero.

Populating the next row the Alice:Video Poker cell must be zero as Alice's entire column total has been used above. The Bob:Video Poker cell is populated with 4—being the remainder that Bob has available. The Charles:Video Poker cell is populated with 5 being the maximum he has available. The remaining values must all be zero as all players values have been allocated. The error values are then calculated. The same method is used to populate tables 5 and 6.

TABLE 4
Initial Allocation - Games

| | | Player: | | | |
|---|---|---|---|---|---|
| Machine | | Alice | Bob | Charles | Error |
| Theme | Totals | 8 | 11 | 5 | 15 |
| Keno | 15 | 8 | 7 | 0 | 0 |
| Video Poker | 15 | 0 | 4 | 5 | 6 |
| Slots | 9 | 0 | 0 | 0 | 9 |
| Error | 0 | 0 | 0 | 0 | 0 |

TABLE 5
Initial Allocation - Coin In

| | | Player: | | | |
|---|---|---|---|---|---|
| Machine | | Alice | Bob | Charles | Error |
| Theme | Totals | 40 | 21 | 10 | 27 |
| Keno | 30 | 30 | 0 | 0 | 0 |
| Video Poker | 53 | 10 | 21 | 10 | 12 |
| Slots | 15 | 0 | 0 | 0 | 15 |
| Error | 0 | 0 | 0 | 0 | 0 |

TABLE 6
Initial Allocation - Coin Out

| | | Player: | | | |
|---|---|---|---|---|---|
| Machine | | Alice | Bob | Charles | Error |
| Theme | Totals | 8 | 30 | 38 | 27 |
| Keno | 38 | 8 | 30 | 0 | 0 |
| Video Poker | 52 | 0 | 0 | 38 | 14 |
| Slots | 13 | 0 | 0 | 0 | 13 |
| Error | 0 | 0 | 0 | 0 | 0 |

A first iteration is then processed. One preferred method is to identify a non zero value and consider a swap of the value or a portion of the value with another cell that is not in the same row or column. Applying a “greedy” approach the largest values may be assessed first. Alternatively using a “maximum descent” approach all possible swaps may be evaluated in each iteration. Whilst a single swap is described for each iteration swaps may affect more than a pair of cells.

In this example we swap the entries for Alice:Keno & Bob:Video Poker. This swap will move 4 in Games table 4, 21 in Coin In table 5, and 0 in Coin Out table 6. These are the minimum of the values in both selected records. Alice:Keno decreases by 4, 21, 0; Bob:Video Poker decreases by 4, 21, 0; Alice:Video Poker increases by 4, 21, 0; and Bob:Keno increases by 3, 21, 0. The values after this iteration are shown in table 7.

TABLE 7
First iteration of table 4 after Swapping Games

| | | Player: | | | |
|---|---|---|---|---|---|
| Machine | | Alice | Bob | Charles | Error |
| Theme | Totals | 8 | 11 | 5 | 15 |
| Keno | 15 | 4 | 11 | 0 | 0 |
| Video Poker | 15 | 4 | 0 | 5 | 6 |
| Slots | 9 | 0 | 0 | 0 | 9 |
| Error | 0 | 0 | 0 | 0 | 0 |

TABLE 8
First iteration of table 5 after Swapping Games
Coin In

| | | Player: | | | |
|---|---|---|---|---|---|
| Machine | | Alice | Bob | Charles | Error |
| Theme | Totals | 40 | 21 | 10 | 27 |
| Keno | 30 | 9 | 21 | 0 | 0 |
| Video Poker | 53 | 31 | 0 | 10 | 12 |
| Slots | 15 | 0 | 0 | 0 | 15 |
| Error | 0 | 0 | 0 | 0 | 0 |

TABLE 9
First iteration of table 6 after Swapping Games
Coin Out

| | | Player: | | | |
|---|---|---|---|---|---|
| Machine | | Alice | Bob | Charles | Error |
| Theme | Totals | 8 | 30 | 38 | 27 |
| Keno | 38 | 8 | 30 | 0 | 0 |
| Video Poker | 52 | 0 | 0 | 38 | 14 |
| Slots | 13 | 0 | 0 | 0 | 13 |
| Error | 0 | 0 | 0 | 0 | 0 |

This swap increases sparsity by one, as the record in Bob, Video Poker is now zero.

Each swap is evaluated to see if it is beneficial or detrimental to a goodness measure. A range of possible goodness measures may be employed but a preferred goodness measure is a weighted combination of factors. One preferred goodness measure includes sparsity and Coin In: Coin Out ratios. It has been found that incentivizing sparsity in the goodness measure assists in driving rapid convergence as well as producing solutions with lower dimensionality that may be more usable.

The weightings may be dependent upon the usage of output information. Greater sparsity may be better where clear trends are desired whereas Coin In: Coin Out ratio may be emphasised where greater accuracy is desired. The weightings may also change during processing—for example emphasising sparsity at the beginning and Coin In: Coin Out ratio towards the end.

A swap satisfying the goodness measure may be retained and one that fails may be rejected and the previous tables reinstated. Processing then goes on to a further iteration (i.e. the next swaps) as outlined above.

The goodness measure may undergo annealing as iterations progress—i.e. a higher level of goodness may be required for a swap to be accepted in later stages of processing. The initial level may in fact be low enough to ensure that a wide range of possible solution paths are explored in early iteration.

In order to consider a wide range of possible solution paths a “Shotgun” approach may be employed where periodically the result at a certain stage of processing is saved and the tables are all re-initialised (Preferably using the Random population technique in paragraph 3 above). By doing this a number of times the possible solution space may be better explored. The values obtained at the end of each processing cycle may be compared to select the result best satisfying the goodness measure. This result may go through further iterations until convergence is achieved.

There is thus provided a method and system enabling the correlation of player and game information via matching of transaction information. Using sparsity as a measure of goodness emphasizes key correlations and drives solution by reducing entries and avoiding data spread.

While the present invention has been illustrated by the description of the embodiments thereof, and while the embodiments have been described in detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the applicant's general inventive concept.

1. A method of correlating player and game information from two sets of gaming information obtained from a plurality of gaming machines wherein a first set of information includes player information and transactional information and a second set of information includes game information and transactional information wherein by optimizing an allocation of transactional information using a goodness measure correlations between player information and game information are obtained.

2. A method as claimed in claim 1 wherein the allocation of transactional information is optimized using an iterative process.

3. A method as claimed in claim 2 wherein iteration is directed by the goodness measure.

4. A method as claimed in claim 3 wherein an attribute of the goodness measure is transactional information sparcity.

5. A method as claimed in claim 3 wherein an attribute of the goodness measure is related to one or more ratio of transactional information.

6. A method as claimed in claim 4 wherein an attribute of the goodness measure is related to one or more ratio of transactional information.

7. A method as claimed in claim 4 wherein weightings are applied to attributes.

8. A method as claimed in claim 7 wherein weightings change over iterations.

9. A method as claimed in claim 8 wherein transactional information sparcity has a higher weighting for earlier iterations than later iterations.

10. A method as claimed in claim 9 wherein the goodness measure is annealed as iterations progress.

11. A method as claimed in claim 10 wherein tables relating players to games are produced for one or more type of transactional information.

12. A method as claimed in claim 11 wherein tables relating players to games are produced for a plurality of types of transactional information.

13. A method as claimed in claim 11 wherein the fields are selected from coin in; coin out, game plays and jackpot.

14. A method as claimed in claim 11 wherein in each iteration consideration is given to exchanging table values and a measure of goodness of the tables with the exchanged values is utilizes to assess whether a change is kept or discarded.

15. A method as claimed in claim 13 wherein in each iteration consideration is given to exchanging table values and a measure of goodness of the tables with the exchanged values is utilizes to assess whether a change is kept or discarded.

16. A method as claimed in claim 14 wherein for each non-zero table value exchanges with all other table locations are considered.

17. A method as claimed in claim 14 wherein for each non-zero value exchanges with all other table locations not in the same row or column are considered.

18. A method as claimed in claim 16 wherein the largest values are considered first.

19. A method as claimed in claim 17 wherein the largest values are considered first.

20. A method as claimed in claim 11 wherein the table cells are initially populated according to rules.

21. A method as claimed in claim 11 wherein the table cells are initially populated in a pseudo random order.

22. A method as claimed in claim 11 wherein the table cells are initially populated in order along a row or column.

23. A method as claimed in claim 11 wherein the table cells are initially populated by allocating table values from the largest to the smallest.

24. A method as claimed claim 11 wherein the tables include total values for each row and column derived from the transactional information.

25. A method as claimed in claim 25 wherein the tables include error values for each row and column being the difference between the row or column total and the sum of the row or column values.

26. A method as claimed in claim 11 wherein a meta-algorithm controls one or more sub algorithm.

27. A method as claimed in claim 20 wherein a meta-algorithm controls one or more sub algorithm.

28. A method as claimed in claim 27 wherein the meta-algorithm resets the initial table values one or more times during processing.

29. A method as claimed in claim 2 wherein processing terminates after a prescribed number of iterations.

30. A method as claimed in claim 3 wherein processing terminates after a prescribed number of iterations.

31. A method as claimed in claim 20 wherein processing terminates after a prescribed number of iterations.

32. A method as claimed in claim 27 wherein processing terminates after a prescribed number of iterations.

33. A method as claimed in claim 2 wherein processing terminates when the goodness measure is within an acceptable range.

34. A method as claimed in claim 3 wherein processing terminates when the goodness measure is within an acceptable range.

35. A method as claimed in claim 20 wherein processing terminates when the goodness measure is within an acceptable range.

36. A method as claimed in claim 27 wherein processing terminates when the goodness measure is within an acceptable range.

37. A method as claimed in claim 2 wherein prior to performing any iterations table values having a high confidence level are frozen.

38. A method as claimed in claim 11 wherein table values are frozen when there is a unique relationship between table values.

39. A method as claimed in claim 20 wherein table values are frozen when there is a unique relationship between table values.

40. A method as claimed in claim 37 wherein table values are frozen when there is a unique relationship between table values.

41. A gaming intelligence system comprising:
a. a plurality of gaming machines, each machine including:
i. a first monitoring unit that stores information relating to a player ID and transaction information; and
ii. a second monitoring unit that stores information relating to a game ID and transaction information,
b. an evaluation system that receives information relating to player ID, game ID and transaction information from the monitoring units and determines correlations between player IDs and game IDs by correlating transaction information.
